(19) United States
(12) Patent Application Publication
(10) Pub. No.: US 2025/0115063 A1
(43) Pub. Date: Apr. 10, 2025

(54) DRYING APPARATUS

(71) Applicant: CANON KABUSHIKI KAISHA, Tokyo (JP)

(72) Inventors: YURI SHIMAMOTO, Chiba (JP); MAKOTO MATSUO, Ibaraki (JP); HIROKI KAJITA, Saitama (JP); NOBUYUKI YOMODA, Chiba (JP); YUSHI SADAMITSU, Tokyo (JP)

(21) Appl. No.: 18/823,874

(22) Filed: Sep. 4, 2024

(30) Foreign Application Priority Data
Oct. 4, 2023 (JP) 2023-172851

(51) Int. Cl. B41J 13/08; B41J 11/00

(52) U.S. Cl. CPC B41J 13/08; B41J 11/0022

(57) ABSTRACT

A drying apparatus includes an opening portion, a conveyance unit, and an adjusting unit. The opening portion receives the sheet conveyed from the printer unit. The conveyance unit includes an endless belt configured to convey the sheet, a first roller configured to stretch the belt, a second roller arranged upstream of the first roller in the conveyance direction and configured to stretch the belt, and a sheet conveyance surface configured to convey the sheet from the second roller toward the first roller on a surface of the belt. The adjusting unit adjusts height of an upstream side in the conveyance direction of the sheet conveyance surface of the belt by pivoting the conveyance unit at a position further downstream than a center of the sheet conveyance surface in the conveyance direction around a pivot shaft arranged along a rotational axis direction of the first roller as a center.

### BACKGROUND OF THE INVENTION

### Field of the Invention

This disclosure relates to a drying apparatus that dries a sheet.

### Description of the Related Art

Hitherto, inkjet recording apparatuses that form an image on a sheet by ink are known. In an inkjet recording apparatus described in Japanese Patent Laid-Open No. 2023-170447, the image is formed on the sheet through an image formation step of forming the image by ejecting the ink onto the sheet, a drying step of drying the ink on the sheet, and a fixing step of fixing the ink on the sheet.

In recent years, for achieving high image quality and high productivity in the digital commercial printing market, industrial inkjet recording apparatuses are used. In the industrial inkjet recording apparatuses, a print module for performing the image formation step, a drying module for performing the drying step, and a fixing module for performing the fixing step are provided in separate casings, and, by interconnecting each casing that has been transported to an installation site, the inkjet recording apparatuses are assembled. To enable the delivery of the sheet between the casings, each casing is adjusted in height, and is interconnected.

### SUMMARY OF THE INVENTION

According to a first aspect of the present invention, a drying apparatus arranged downstream of a printer unit configured to form an image on a sheet in a conveyance direction of the sheet and interconnected to the printer unit comprises an opening portion configured to receive the sheet conveyed from the printer unit, the conveyance unit including an endless belt configured to convey the sheet, a first roller configured to stretch the belt, a second roller arranged upstream of the first roller in the conveyance direction and configured to stretch the belt, and a sheet conveyance surface configured to convey the sheet from the second roller toward the first roller on a surface of the belt, and an adjusting unit configured to adjust height of an upstream side in the conveyance direction of the sheet conveyance surface of the belt by pivoting the conveyance unit at a position further downstream than a center of the sheet conveyance surface in the conveyance direction around a pivot shaft arranged along a rotational axis direction of the first roller as a center.

Further features of the present invention will become apparent from the following description of exemplary embodiments with reference to the attached drawings.

### BRIEF DESCRIPTION OF THE DRAWINGS

FIG. 1 is a schematic diagram illustrating an inkjet recording apparatus of this embodiment.

FIG. 2 is a schematic diagram illustrating a print module and a drying module.

FIG. 3 is a perspective view illustrating a decoupling belt unit.

FIG. 4 is a schematic diagram illustrating a decoupling belt unit provided with a second adjustment mechanism.

### DESCRIPTION OF THE EMBODIMENTS

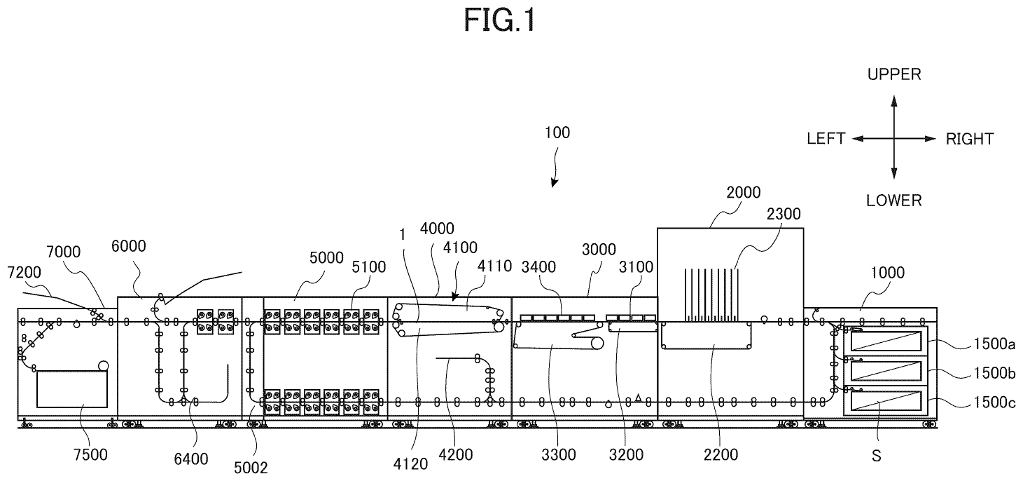

Using drawings, the present embodiment will be described. First, using FIG. 1, a schematic configuration of an inkjet recording apparatus of the present embodiment will be described. An inkjet recording apparatus 100 of the present embodiment uses an inkjet recording method that forms an image on a sheet S by ejecting ink, and is a so-called sheet-fed inkjet recording apparatus that forms an ink image on the sheet using a two-liquid system of reaction liquid and the ink. Any sheet S, for example, paper such as regular paper and cardboard, a plastic film such as a sheet for an overhead projector, a sheet of a special shape such as an envelope and index paper, cloth, and the like is acceptable as long as the sheet is a recording material that can accept the ink.

To be noted, in this specification, a side on which a worker stands when operating the inkjet recording apparatus 100 is referred to as a “front side” (or front), and the opposite side is referred to as a “back side” (or back). In addition, the left side when viewed from the front side is referred to as “left”, and the right side when viewed from the front side is referred to as “right”.

As illustrated in FIG. 1, the inkjet recording apparatus 100 of the present embodiment is an example of an image forming apparatus, and includes a feed module 1000, a print module 2000, a drying module 3000, a fixing module 4000, a cooling module 5000, a reverse module 6000, and a supporting module 7000. The sheet S supplied from the feed module 1000 undergoes various processing during a time when the sheet is conveyed along a sheet conveyance path inside of each module, and is finally discharged to the supporting module 7000.

The feed module 1000, the print module 2000, the drying module 3000, the fixing module 4000, the cooling module 5000, the reverse module 6000, and the supporting module 7000 each include a distinct casing, and the inkjet recording system 100 is constituted by interconnecting these distinct casings.

The feed module 1000 includes storage compartments 1500a, 1500b, and 1500c that store the sheet S, and the storage compartments 1500a to 1500c are withdrawable toward a front side of the apparatus so as to store the sheet S inside. In each of the storage compartments 1500a to 1500c, the sheet S is fed by a separation belt and a conveyance roller, not shown, one sheet at a time, and is conveyed to the print module 2000. To be noted, the number of the storage compartments 1500a to 1500c is not limited to three, and the feed module 1000 may include one, or two, or equal to or more than four storage compartments.

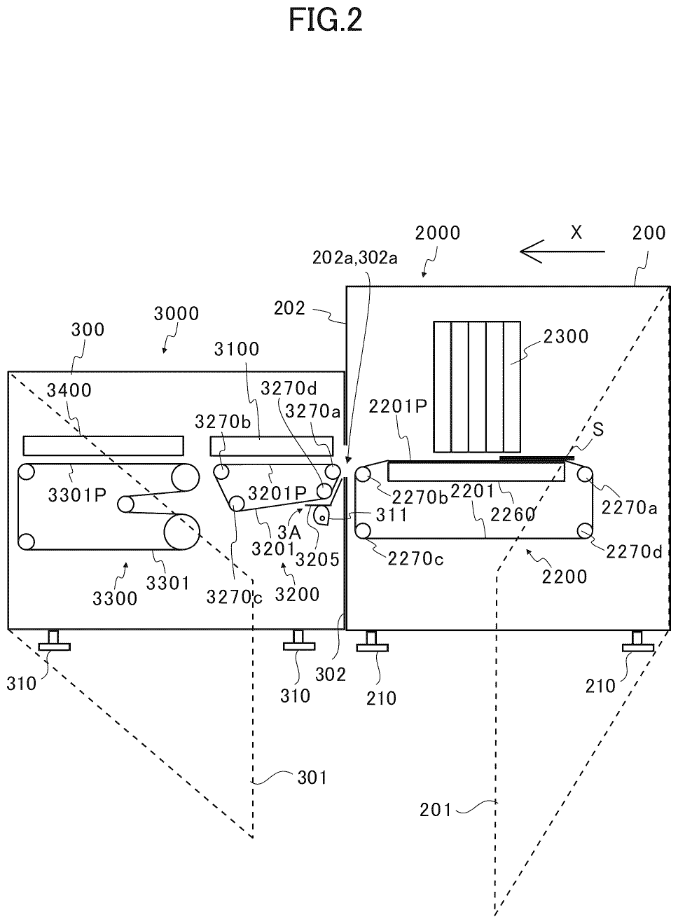

The print module 2000 that is an example of a printer unit includes a pre-image formation conveyance unit, not shown, a print belt unit 2200, and a recording unit 2300, and forms the image by ejecting the ink onto the sheet S. The pre-image formation conveyance unit corrects the skew and a position of the sheet S conveyed from the feed module 1000, and, thereafter, the sheet S is conveyed to the print belt unit 2200. The recording unit 2300 is located at a position facing the print belt unit 2200 with respect to a sheet conveyance path. The recording unit 2300 forms the image on the sheet S by ejecting the ink with respect to the conveyed sheet S through recording heads, not shown, from above. The print module 2000 will be described in detail below (FIG. 2).

The drying module 3000 is an example of a drying apparatus, provided downstream of the print module 2000 in a conveyance direction (arrow X direction) of the sheet S, and connected with the print module 2000. The drying module 3000 includes a cold air blowing unit 3100, a decoupling belt unit 3200, a drying belt unit 3300, and a warm air blowing unit 3400. So as to facilitate the fixing of the ink on the sheet S by the subsequent fixing module 4000, the drying module 3000 reduces liquid contents in the ink and the reaction liquid applied to the sheet S. The drying module 3000 will be described in detail below (FIG. 2).

The fixing module 4000 includes a fixing belt unit 4100. The fixing belt unit 4100 fixes the ink on the sheet S by passing the sheet S, which has been conveyed from the drying module 3000 and bears the printed image, through a heated upper belt unit 4110 and a lower belt unit 4120. The fixing belt unit 4100 will be described in detail below.

The cooling module 5000 includes a plurality of cooling units 5100, and cools a high temperature sheet S, which has been conveyed from the fixing module 4000, by the cooling units 5001. The cooling unit 5100, for example, increases pressure in an interior of a cooling box by drawing exterior air into the interior of the cooling box through a fan. Then, utilizing this pressure, the air is expelled from the cooling box through nozzles, which are directed onto the sheet S to cool the sheet S. The cooling units 5100 are arranged on both sides with respect to the sheet conveyance path, and cool both surfaces of the sheet S.

A conveyance path switching portion 5002 is disposed in the cooling module 5000. The conveyance path switching portion 5002 switches the sheet conveyance path depending on whether the sheet S is conveyed to the reverse module 6000 or to duplex conveyance paths used during duplex printing in which the image is formed on both the surfaces of the sheet S.

The reverse module 6000 includes a reverse portion 6400. The reverse portion 6400 reverses the front and back surfaces of the sheet S discharged to the supporting module 7000 by reversing the front and back surfaces of the sheet S that is conveyed. The supporting module 7000 includes a top tray 7200 and a supporting portion 7500, and stacks the sheet S conveyed from the reverse module 6000.

During the duplex printing, the sheet S is conveyed through a sheet conveyance path located in a lower section of the cooling module 5000 by the conveyance path switching portion 5002. Thereafter, the sheet S is returned to the print module 2000 by passing through duplex conveyance paths of the fixing, drying, print, and feed modules 4000, 3000, 2000, and 1000. A reverse portion 4200 reversing the front and back surfaces of the sheet S is disposed in a duplex conveyance unit of the fixing module 4000. The image is formed also on an unprinted other surface of the sheet S that has been returned to the print module 2000, and the sheet S is discharged to the supporting module 7000 via the drying module 3000, fixing module 4000, cooling module 5000, and the reverse module 6000.

### Print Module

Next, using FIG. 2, the print module 2000 will be described. As illustrated in FIG. 2, the print module 2000 includes the print belt unit 2200 and the recording unit 2300, and these units are enclosed within a casing 200, serving as a first casing. On the front side of the casing 200, an openable and closable front cover 201 is disposed, and, by opening the front cover 201, the worker can perform such as the maintenance and the replacement of the print belt unit 2200 and the recording unit 2300, if necessary.

A side surface cover 202 is disposed on a side surface of the casing 200 on a side of the drying module 3000, and a discharge port 202a for discharging the sheet S from the print module 2000 to the drying module 3000 is formed in the side surface cover 202. On a bottom surface of the casing 200, height adjustable leg portions 210 are arranged at each of four corners, and the casing 200 is moved vertically in response to height adjustments of these leg portions 210. Thereby, the height of the print belt unit 2200 and the recording unit 2300, further the discharge port 202a from an installation surface is changed.

With respect to the conveyance path of the sheet S, the recording unit 2300 is arranged at a position facing the print belt unit 2200. The recording unit 2300 forms the image on the sheet S by ejecting the ink from above with respect to the conveyed sheet S by a plurality of recording heads. The sheet S is conveyed via suction by the print belt unit 2200, and clearance with the recording heads is secured. In this embodiment, five line-type recording heads corresponding to four colors of yellow (Y), magenta (M), cyan (C), and black (Bk), and a reaction liquid are arranged along the conveyance direction (arrow X direction) of the sheet S.

The sheet S is conveyed by the print belt unit 2200, serving as a first conveyance unit. The print belt unit 2200 includes an endless print belt 2201, a plurality of stretching rollers 2270a, 2270b, 2270c, and 2270d that rotatably stretch the print belt 2201, and a suction unit 2260. At least one of the stretching rollers 2270a, 2270b, 2270c, and 2270d is a drive roller that rotatably drives the print belt 2201.

The print belt 2201, serving as a first belt, is arranged below the recording unit 2300 in a vertical direction, and conveys the sheet S by rotating. With respect to a rotational direction of the print belt 2201, both sides of a sheet conveyance surface 2201P that conveys the sheet S are stretched by a pair of the stretching rollers 2270a and 2270b. The sheet S is borne and conveyed by the sheet conveyance surface 2201P of the rotating print belt 2201 to achieve a predetermined gap (print gap) with the recording unit 2300 (in particular, tips of ink ejection nozzles of the recording heads) corresponding to the thickness of the sheet S. To achieve this, numerous fine holes allowing air passage are formed across an entire circumference of the print belt 2201, and the suction unit 2260 is arranged below an upper portion of the print belt 2201 in the vertical direction. The suction unit 2260 draws air downward to adhere the sheet S onto the sheet conveyance surface 2201P of the print belt 2201. Thereby, the clearance between the sheet S and the recording heads is secured.

To be noted, as means to adjust the gap between the tips of the ink ejection nozzles of the recording heads described above and the sheet S, methods include moving the recording unit 2300, or moving the print belt unit 2200. In this embodiment, from the standpoint of mitigating color misregistration and preventing the enlargement of the apparatus, the print belt unit 2200 is moved. In addition, the thickness of the sheet S may be determined from information that the worker inputs through such as an operation panel, not shown, or may be determined from a detection signal of a thickness detection sensor, not shown, arranged further upstream than the recording unit 2300 in the sheet conveyance direction.

To be noted, the variety of colors and the number of the recording heads in the print module 2000 are not respectively limited to four and five. Methods using such as a heating element, a piezoelectric element, an electrostatic element, and a micro electromechanical system (MEMS) element can be adopted to an inkjet method. The ink of each color is supplied from an ink tank, not shown, to each of the recording heads through an ink tube. The sheet S printed in the recording unit 2300 is conveyed by the print belt unit 2200, and it is possible to correct the printed image by detecting the misalignment and the color density of the image with an inline scanner, not shown, arranged downstream of recording unit in the sheet conveyance direction.

### Drying Module

Next, using FIG. 2, the drying module 3000 will be described. As illustrated in FIG. 2, the drying module 3000 includes the cold air blowing unit 3100, the decoupling belt unit 3200, the drying belt unit 3300, and the warm air blowing unit 3400, and these units are enclosed within a casing 300, serving as a second casing. An openable and closable front cover 301 is disposed on the front side of the casing 300, and, by opening the front cover 301, the worker can perform such as the maintenance and the replacement of the cold air blowing unit 3100, the decoupling belt unit 3200, the drying belt unit 3300, and the warm air blowing unit 3400, if necessary.

A side surface cover 302 is disposed on a side surface of the casing 300 on a side of the print module 2000, and a receiving port 302a that receives the sheet S discharged from the print module 2000 into the drying module 3000 is formed in the side surface cover 302. The receiving port 302a is an example of an opening portion. On a bottom surface of the casing 300, leg portions 310, functioning as height change portions that can change the height of the casing 300, are arranged one at each of four corners. That is, the leg portions 310 are examples of change portions, and can change the height of the drying module 3000 with respect to the print module 2000. In response to changes in the length of the leg portions 310, the casing 300 is moved vertically. Thereby, the height of the cold air blowing unit 3100, the decoupling belt unit 3200, the drying belt unit 3300, and the warm air blowing unit 3400, further the receiving port 302a from the installation surface is changed.

In the drying module 3000, the sheet S on which the image has been formed by the print module 2000 is conveyed by the decoupling belt unit 3200 that is an example of the first conveyance unit (conveyance unit). The decoupling belt unit 3200 includes an endless decoupling belt 3201, a plurality of stretching rollers 3270a, 3270b, 3270c, and 3270d that rotatably stretch the decoupling belt 3201, and a sheet conveyance surface 3201P. At least one of the stretching rollers 3270a, 3270b, 3270c, and 3270d is a drive roller that rotatably drives the decoupling belt 3201. The decoupling belt 3201 is an example of a belt (first belt), and conveys the sheet S by rotating. The decoupling belt 3201 is stretched by the stretching roller 3270b, serving as a first roller, on a downstream side of the sheet conveyance surface 3201P in the sheet conveyance direction, and is stretched by the stretching roller 3270a, serving as a second roller, on an upstream side of the sheet conveyance surface 3201P in the sheet conveyance direction. That is, the stretching roller 3270a is arranged upstream with respect to the stretching roller 3270b in the sheet conveyance direction, and stretches the decoupling belt 3201. In addition, the sheet conveyance surface 3201P is a surface that conveys the sheet S from the stretching roller 3270a toward the stretching roller 3270b on a surface (upper surface) of the decoupling belt 3201.

To be noted, in the decoupling belt unit 3200 of this embodiment, the sheet S is not conveyed via the suction. Therefore, the decoupling belt unit 3200 does not include a fan for the suction. This is to ensure that the decoupling belt unit 3200 does not exert any pulling force on the sheet S on which the image is being formed in the print module 2000.

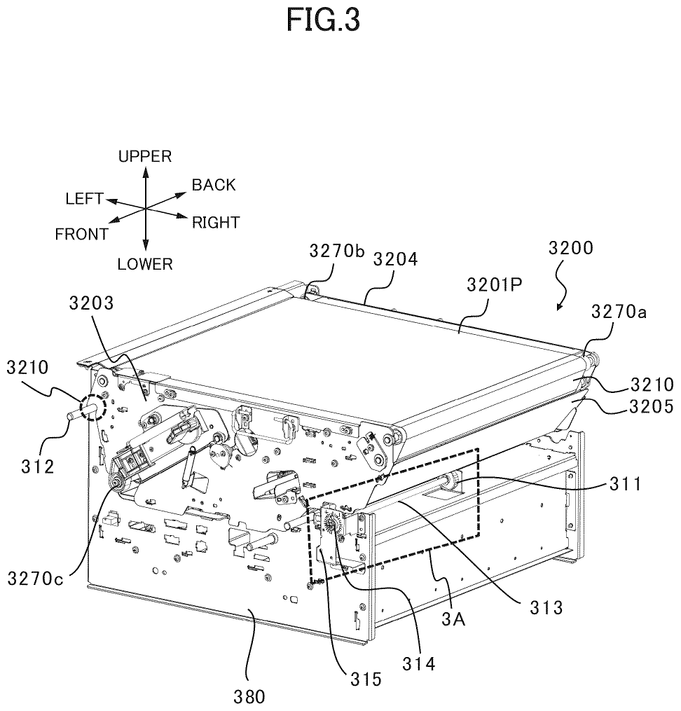

Steering control is performed in one of the stretching rollers, such as the stretching rollers 3270c and 3270d, that stretch the decoupling belt 3201 in areas other than the sheet conveyance surface 3201P. In the steering control, the roller is swinged. By performing the steering control, the belt is prevented from being moved in front and back directions (refer to arrows front and back in FIG. 3) to be derailed from the roller.

In the decoupling belt unit 3200, by the pressure of cold airflow blown from the cold air blowing unit 3100, a friction force is generated between the sheet S and the decoupling belt 3201, and the sheet S is borne and conveyed by the decoupling belt 3201. Thereby, by conveying the sheet S using the friction force as described above, when the sheet S is conveyed across the print belt unit 2200 and the decoupling belt unit 3200, the sheet S is prevented from being conveyed in a state of being pulled toward a side of the decoupling belt unit 3200.

The sheet S conveyed by the decoupling belt unit 3200 is delivered to the drying belt unit 3300 that is an example of a second conveyance unit. The drying belt unit 3300 includes an endless drying belt 3301 and a plurality of stretching rollers that rotatably stretch the drying belt 3301. At least one of the stretching rollers is a drive roller that rotatably drives the drying belt 3301. The drying belt 3301 is an example of a second belt, is arranged downstream of the decoupling belt unit 3200 in the sheet conveyance direction, and conveys the sheet S delivered by the decoupling belt 3201. In the drying belt unit 3300, the ink applied onto the sheet S is dried by blowing warm airflow from the warm air blowing unit 3400. Using this, in the drying belt 3301, by the pressure of the warm airflow blown from the warm air blowing unit 3400, the sheet S is borne and conveyed on a sheet conveyance surface 3301P. To be noted, as an ink drying method, in addition to a warm airflow blowing method, it is acceptable to appropriately combine other methods such as an electromagnetic wave method, which irradiates the sheet S with an electromagnetic wave (such as ultraviolet or infrared rays), or a conductive heat transfer method, which involves contact with a heating element.

In this embodiment, in a state in which, when a leading edge of the sheet S in the sheet conveyance direction has reached the decoupling belt unit 3201, a trailing edge of the sheet S in the sheet conveyance direction is located on the print belt 2201, the image is formed with respect to the sheet S by the recording unit 2300. At this time, to prevent image defects such as the color misregistration with respect to the sheet S, a sheet conveyance force of the decoupling belt 3201 is set to be smaller than a sheet conveyance force of the print belt 2201.

As described above, in the print module 2000, the sheet S is conveyed via the suction by the print belt 2201. To convey the sheet S by the conveyance force smaller than the conveyance force of this print belt 2201, in the drying module 3000, as described above, the sheet S is conveyed by the friction force generated by blowing the cold airflow from the cold air blowing unit 3100. In addition, the decoupling belt 3201 is rotated at a speed faster than the print belt 2201. For example, the decoupling belt 3201 is rotated at a speed approximately 3% faster than the print belt 2201. Thereby, since, during when the trailing edge of the sheet S is located on the print belt 2201, the sheet is conveyed while sliding on the decoupling belt 3201, the sheet S is not conveyed in a state of being pulled toward the side of the decoupling belt unit 3200.

However, in a case where the conveyance force of the decoupling belt 3201 is smaller than the conveyance force of the print belt 2201, if a difference in level occurs between a downstream end of the sheet conveyance surface 2201P of the print belt 2201 and an upstream end of the sheet conveyance surface 3201P of the decoupling belt 3201 in the sheet conveyance direction, there is a risk that the defective conveyance of the sheet S may occur. In a case where the print belt 2201 and the decoupling belt 3201 are disposed in the separate casings 200 and 300, as described above, even if the height of the casings 200 and 300 is adjusted, there is a possibility that the height of the downstream end of the sheet conveyance surface 2201P and the upstream end of the sheet conveyance surface 3201P may not align due to such as component tolerances, and there is a risk that the difference in the level may occur.

### Adjustment Mechanism

Therefore, in this embodiment, to align the height of the downstream end of the sheet conveyance surface 2201P and the upstream end of the sheet conveyance surface 3201P, a height adjustment of the upstream end of the sheet conveyance surface 3201P of the decoupling belt 3201 is made possible. To achieve this, a first adjustment mechanism 3A, serving as an adjusting unit (first adjusting unit) is disposed in the drying module 3000. Hereinafter, using FIGS. 2 and 3, the first adjustment mechanism 3A will be described.

As illustrated in FIG. 2, the first adjustment mechanism 3A is arranged under the decoupling belt unit 3200 in the drying module 3000. In this embodiment, an upstream height of the sheet conveyance surface 3201P is changed in response to the first adjustment mechanism 3A coming into contact with the decoupling belt unit 3200 from below and pivoting the decoupling belt unit 3200 around a pivot shaft as a center.

As illustrated in FIG. 3, the decoupling belt unit 3200 is rotatably supported by a supporting portion 380 secured to the casing 300. In the supporting portion 380, the pivot shaft 312 is disposed at a downstream end portion in the sheet conveyance direction. In more particular, the pivot shaft 312 is arranged further downstream than a center of the sheet conveyance surface 3201P in the sheet conveyance direction and along a rotational axis direction of the stretching roller 3270b. In this embodiment, the pivot shaft 312 is arranged further downstream than the stretching roller 3270b in the sheet conveyance direction. That is, when viewed from a vertical direction, the pivot shaft 312 is arranged not to overlap the stretching roller 3270b. However, it is not limited to this, and, even if, when viewed from the vertical direction, the pivot shaft 312 overlaps the stretching roller 3270b, the pivot shaft 312 may be arranged further downstream than a rotational axis of the stretching roller 3270b in the conveyance direction, or the pivot shaft 312 may be arranged such that a rotational axis of the pivot shaft 312 is arranged further downstream than the rotational axis of the stretching roller 3270b in the conveyance direction.

The decoupling belt unit 3200 includes a front-side plate 3203 on the front side and a back-side plate 3204 on the back side across the decoupling belt 3201. The front-side and back-side plates 3203 and 3204 rotatably support shafts of the stretching rollers 3270a, 3270b, 3270c, and 3270d that stretch the decupling belt 3201. In these front-side and back-side plates 3203 and 3204, hook portions 3210 that pivotably engage with the pivot shaft 312 are formed. On the downstream side in the sheet conveyance direction, the decoupling belt unit 3200 is supported by the pivot shaft 312 via the hook portions 3210, which are examples of an engagement portion.

To be noted, by supporting the decoupling belt unit 3200 by the pivot shaft 312 via the hook portions 3210, in the sheet conveyance direction, the downstream height of the sheet conveyance surface 3201P is substantially aligned with the upstream height of the sheet conveyance surface 3301P of the drying belt 3301. To be noted, it is acceptable to rotatably support the decoupling belt unit 3200 by the supporting portion 380 by disposing the hook portions 3210 in the supporting portion 380 and disposing the pivot shaft 312 in the decoupling belt unit 3200.

The decoupling belt unit 3200 includes a guard plate 3205 on the upstream side in the sheet conveyance direction to protect the decoupling belt 3201. The guard plate 3205 is arranged between the front-side and back-side plates 3203 and 3204 in a manner covering part of the decoupling belt 3201 stretched over the stretching rollers 3270a and 3270d. The first adjustment mechanism 3A is disposed to the supporting portion 380 in a manner coming into contact with this guard plate 3205. The first adjustment mechanism 3A is secured to the supporting portion 380 by a securing portion 315.

The first adjustment mechanism 3A includes an upstream adjustment cam 311, an adjustment dial 314, and a rod-like member 313 connecting these upstream adjustment cam 311 and adjustment dial 314. The rod-like member 313 is rotatably supported by the securing portion 315. The adjustment dial 314 is fitted to a first end on the front side of the rod-like member 313, and the upstream adjustment cam 311 is fitted to a second end of the rod-like member 313. The rod-like member 313 is rotatably supported by the supporting portion 380, and is arranged along the rotational axis direction of the stretching roller 3270d. That is, in a case where the adjustment dial 314 is rotated by an external force, the rod-like member 313 rotates to turn the upstream adjustment cam 311.

The upstream adjustment cam 311 is an example of an eccentric cam, and is secured to the rod-like member 313 to come into contact with the decoupling belt unit 3200. In this embodiment, the upstream adjustment cam 311 comes into contact with the guard plate 3205 of the decoupling belt unit 3200. Therefore, when the upstream adjustment cam 311 is rotated in conjunction with the rod-like member 313, since the decoupling belt unit 3200 pivots around the pivot shaft 312 as a center, the upstream side of the decoupling belt unit 3200 in the sheet conveyance direction is lifted or lowered with respect to the supporting portion 380. As described above, in the drying module 3000, in the sheet conveyance direction, the upstream height of the sheet conveyance surface 3201P is changed.

The adjustment dial 314, which is an example of an operation portion, includes, for example, a dial that a user can manually rotate in steps at a predetermined angle. When an operation is performed to rotate the dial by one step, the upstream adjustment cam 311 rotates by, for example, 12 degrees. The upstream adjustment cam 311 changes a cam lobe radius of contact with the guard plate 3205 by approximately 0.066 millimeters (mm) per every 12 degrees of rotation. In this embodiment, to enable the worker to manually adjust the upstream height of the sheet conveyance surface 3201P in the sheet conveyance direction, the adjustment dial 314 is provided with graduated scales in “0.5 mm” increments indicating a variation amount of the upstream height of the sheet conveyance surface 3201P. Thereby, the worker can finely adjust the upstream height of the sheet conveyance surface 3201P in the sheet conveyance direction by operating the adjustment dial one increment at a time while observing the scale. As described above, by pivoting the decoupling belt unit 3200 around the pivot shaft 312 as a center, the first adjustment mechanism 3A can adjust the upstream height in the sheet conveyance direction of the sheet conveyance surface 3201P of the decoupling belt 3201 stretched by the stretching roller 3270a.

As described above, in this embodiment, in the drying module 3000 that is interconnected downstream of the print module 2000 in the sheet conveyance direction, the first adjustment mechanism 3A that pivots the decoupling belt unit 3200 in steps is disposed. By pivoting the decoupling belt unit 3200 using the first adjustment mechanism 3A, in the sheet conveyance direction, the upstream height of the sheet conveyance surface 3201P of the decoupling belt 3201 is aligned with the downstream height of the sheet conveyance surface 2201P of the print belt 2201. According to this embodiment, even if, in spite of having adjusted the height of the casing 200 of the print module 2000 and the casing 300 of the drying module 3000, the downstream height of the sheet conveyance surface 2201P does not align with the upstream height of the sheet conveyance surface 3201P due to such as the component tolerances, the worker can easily adjust the height by opening the front cover 301 and operating the first adjustment mechanism 3A. Therefore, the difference in the level does not occur between the downstream end of the sheet conveyance surface 2201P and the upstream end of the sheet conveyance surface 3201P in the sheet conveyance direction, and it is possible to suppress the occurrence of the defective conveyance of the sheet S conveyed between the casings.

According to this disclosure, in the inkjet recording apparatus in which the first and second casings are interconnected, it is possible to align the height of the first and second belts that perform the delivery of the sheet between these casings.

### Other Embodiments

To be noted, while, in the embodiment described above, the upstream adjustment cam 311 is brought into contact with the guard plate 3205 of the decoupling belt unit 3200 to enable the height adjustment, it is not limited to this. For example, it is acceptable that, in the front-side and back-side plates 3203 and 3204, the upstream adjustment cams 311 are brought into contact with bearing portions, not shown, supporting the shaft of the stretching roller 3270a to enable the height adjustment, or the upstream adjustment cams 311 are brought into contact with edges of the front-side and back-side plates 3203 and 3204 to enable the height adjustment. Alternately, the first adjustment mechanism 3A may be provided in the decoupling belt unit 3200, and the supporting portion 380 may include a contact portion with which the upstream adjustment cam 311 is engaged.

To be noted, a plurality of upstream adjustment cams 311 of the same shape and phase may be fitted to the rod-like member 313, or one or more upstream adjustment cams 311 may be fitted to the rod-like members 313, which are separately arranged at equal to or more than two positions in the sheet conveyance direction.

To be noted, it is acceptable that, without providing the adjustment dial 314, the rod-like member 313 is rotatably driven by a motor. In such a case, the upstream height of the sheet conveyance surface 3201P in the sheet conveyance direction may be configured to be automatically adjusted by controlling a motor to rotate the upstream adjustment cam 311 via the rod-like member 313 in response to the adjustment of the print gap by the movement of the print belt 2200.

Incidentally, in the drying module 3000, to perform the drying corresponding to the characteristics of the sheet S and the printed image, it is necessary to form an appropriate gap (drying gap) between the warm air blowing unit 3400 and the sheet S. In this embodiment, from the standpoint of suppressing the enlargement of the apparatus, the drying belt unit 3300 is moved vertically to form the appropriate drying gap. However, when the drying belt unit 3300 is moved, there is a risk that, in the sheet conveyance direction, the downstream end of the sheet conveyance surface 3201P of the decoupling belt unit 3200 and the upstream end of the sheet conveyance surface 3301P of the drying belt unit 3300 may lose height alignment.

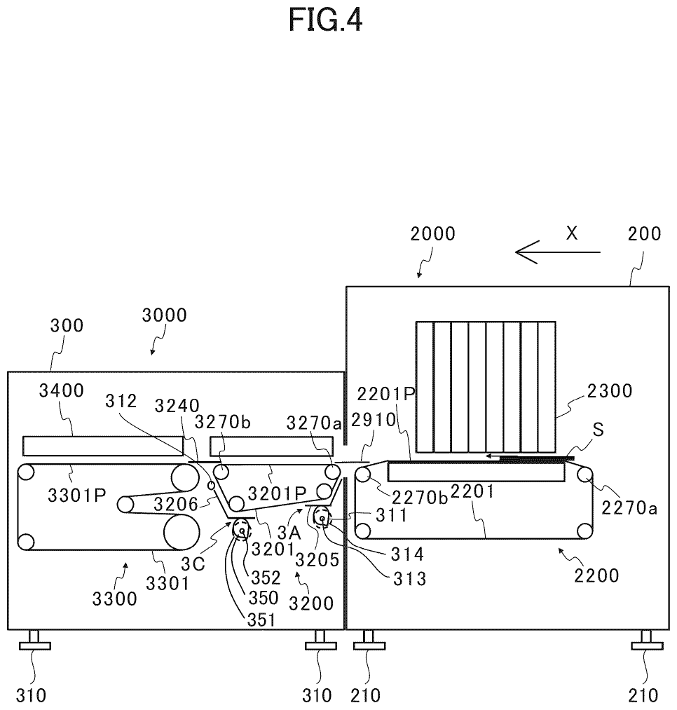

Therefore, in the sheet conveyance direction, to align the downstream height of the sheet conveyance surface 3201P and the upstream height of the sheet conveyance surface 3301P, the downstream height of the sheet conveyance surface 3201P of the decoupling belt 3201 is preferably made adjustable. To achieve this, a second adjustment mechanism 3C is disposed downstream of the decoupling belt unit 3200 in the sheet conveyance direction. FIG. 4 illustrates a case where the second adjustment mechanism 3C is disposed downstream of the decoupling belt unit 3200 in the sheet conveyance direction. To be noted, descriptions of configurations which are the same as the print module 2000 and the drying module 3000 illustrated in FIG. 2 will be simplified or omitted herein by putting the same reference characters on a drawing.

As illustrated in FIG. 4, the second adjustment mechanism 3C, serving as a second adjusting unit, moves the downstream side of the decoupling belt unit 3200 in the vertical direction. The second adjustment mechanism 3C includes a downstream adjustment cam 350, a link member 3206, and the adjustment dial 351 and the rod-like member 352. The downstream adjustment cams 350 are arranged outside of the front-side and back-side plates 3203 and 3204 (refer to FIG. 3) of the decoupling belt unit 3200. The link members 3206 are disposed outside of the front-side and back-side plates 3203 and 3204 so as to move vertically with a first end coming into contact with the pivot shaft 312 and a second end coming into contact with the downstream adjustment cam 350. In addition, in this case, the pivot shaft 312 is movable with respect to the front-side plate 3203 vertically.

In a case where the adjustment dial 351 is rotated by an external force, the rod-like member 352 rotates to turn the downstream adjustment cam 350. The downstream adjustment cam 350 is an example of an eccentric cam, and comes into contact with the second end of the link member 3206. Therefore, when the downstream adjustment cam 350 is rotated, the link member 3206 moves, and the first end of the link member 3206 moves the pivot shaft 312 vertically. Thereby, the decoupling belt unit 3200 pivots around a contact position of the decoupling belt unit 3200 and the upstream adjustment cam 311 as a pivot axis, and, in the sheet conveyance direction, the downstream side of the decoupling belt unit 3200 is lifted with the decoupling belt unit 3200 coming into contact with the upstream adjustment cam 311. As described above, in the drying module 3000, it is possible to adjust the downstream height of the sheet conveyance surface 3201P in the sheet conveyance direction. Even in a case where the drying belt unit 3300 is moved as described above, the difference in the level does not occur between the downstream end of the sheet conveyance surface 3201P and the upstream end of the sheet conveyance surface 3301P in the sheet conveyance direction, and it is possible to suppress the defective conveyance of the sheet S conveyed from the decoupling belt 3201 to the drying belt 3301.

In addition, as illustrated in FIG. 4, between the sheet conveyance surface 2201P of the print belt 2201 and the sheet conveyance surface 3201P of the decoupling belt 3201, it is acceptable to dispose a first conveyance guide 2910 guiding the sheet S. In a case of this embodiment, the first conveyance guide 2901 is secured to the front-side and back-side plates 3203 and 3204 of the decoupling belt unit 3200 (refer to FIG. 3). Therefore, in a case where the decoupling belt unit 3200 is pivoted by the first adjustment mechanism 3A, the first conveyance guide 2910 moves by following the movement of the upstream end of the sheet conveyance surface 3201P. As described above, since the height of the first conveyance guide 2910 changes synchronously with the upstream height of the sheet conveyance surface 3201P in the sheet conveyance direction, it is possible to stably convey the sheet S between the casings 200 and 300 by the first conveyance guide 2910, and it is possible to suppress the defective conveyance of the sheet S conveyed between the casings.

Further, between the sheet conveyance surface 3201P of the decoupling belt 3201 and the sheet conveyance surface 3301P of the drying belt 3301, it is acceptable to dispose a second conveyance guide 3240 for guiding the sheet S. In the case of this embodiment, the second conveyance guide 3240 is secured to the front-side and back-side plates 3203 and 3204 of the decoupling belt unit 3200 (refer to FIG. 3). That is, the second conveyance guide 3240 is an example of a conveyance guide, is disposed in the decoupling belt unit 3200, guides the sheet S conveyed by the decoupling belt 3201 to the drying belt 3301, and moves synchronously with the pivot of the decoupling belt unit 3200 by the first or second adjustment mechanism 3A or 3C. Therefore, in a case where the decoupling belt unit 3200 is pivoted by the second adjustment mechanism 3C, the second conveyance guide 3240 moves by following the movement of the downstream end of the sheet conveyance surface 3201P in the sheet conveyance direction. As described above, in the sheet conveyance direction, since the height of the second conveyance guide 3240 changes synchronously with the downstream height of the sheet conveyance surface 3201P, even if the downstream height of the sheet conveyance surface 3201P changes, it is possible to stably convey the sheet S between the casings 200 and 300 by the second conveyance guide 3240.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-172851, filed Oct. 4, 2023 which is hereby incorporated by reference herein in its entirety.

What is claimed is:

1. A drying apparatus arranged downstream of a printer unit configured to form an image on a sheet in a conveyance direction of the sheet and interconnected to the printer unit, the drying apparatus comprising:
an opening portion configured to receive the sheet conveyed from the printer unit;
a conveyance unit including an endless belt configured to convey the sheet, a first roller configured to stretch the belt, a second roller arranged upstream of the first roller in the conveyance direction and configured to stretch the belt, and a sheet conveyance surface configured to convey the sheet from the second roller toward the first roller on a surface of the belt; and
an adjusting unit configured to adjust height of an upstream side in the conveyance direction of the sheet conveyance surface of the belt by pivoting the conveyance unit at a position further downstream than a center of the sheet conveyance surface in the conveyance direction around a pivot shaft arranged along a rotational axis direction of the first roller as a center.

2. The drying apparatus according to claim 1,
wherein the belt is a first belt, and the conveyance unit is a first conveyance unit, and
wherein the drying apparatus comprises a second conveyance unit arranged downstream of the first conveyance unit in the conveyance direction and including a second endless belt configured to convey the sheet received from the first belt.

3. The drying apparatus according to claim 1, wherein the pivot shaft is arranged downstream of a rotational axis the first roller in the conveyance direction.

4. The drying apparatus according to claim 1, further comprising:
a supporting portion configured to support the conveyance unit,
wherein the pivot shaft is arranged at a downstream end portion of the supporting portion in the conveyance direction, and
wherein the conveyance unit includes an engagement portion configured to pivotably engage with the pivot shaft.

5. The drying apparatus according to claim 4,
wherein the adjusting unit includes a rod-like member rotatably arranged to the supporting portion along the rotational axis direction, and an eccentric cam fixed to the rod-like member and configured to come into contact with the conveyance unit, and
wherein the adjusting unit is configured to pivot the conveyance unit by the eccentric cam that rotates in conjunction with the rod-like member.

6. The drying apparatus according to claim 5, wherein the rod-like member includes an operation portion that a user can rotate manually.

7. The drying apparatus according to claim 5,
wherein the adjusting unit is a first adjusting unit,
wherein the drying apparatus comprises a second adjusting unit, and
wherein in a state where the eccentric cam is brought into contact with the conveyance unit, the second adjusting unit is configured to adjust height of a downstream side in the conveyance direction of the sheet conveyance surface of the belt by pivoting the conveyance unit around a contact position with the eccentric cam as a center.

8. The drying apparatus according to claim 2, further comprising:
a conveyance guide disposed in the first conveyance unit and configured to guide the sheet conveyed by the first belt toward the second belt,
wherein the conveyance guide is configured to move in conjunction with a pivot of the conveyance unit by the adjusting unit.

9. The drying apparatus according to claim 1. further comprising:
a height change portion configured to change height of the drying apparatus with respect to the printer unit.
